(19) United States
(12) Patent Application Publication
(10) Pub. No.: US 2013/0054951 A1
(43) Pub. Date: Feb. 28, 2013

(54) SOFTWARE EXECUTION METHOD AND ELECTRONIC DEVICE USING THE SAME

(71) Applicants: Hong-Ming Liu, Shanghai (CN); Kun-Ming Yi, Zhejiang (CN); Dan-Dan Wei, Shanghai (CN); Xiang Long, Shanghai (CN)

(72) Inventors: Hong-Ming Liu, Shanghai (CN); Kun-Ming Yi, Zhejiang (CN); Dan-Dan Wei, Shanghai (CN); Xiang Long, Shanghai (CN)

(73) Assignee: NOVATEK MICROELECTRONICS CORP., Hsinchu (TW)

(21) Appl. No.: 13/459,251

(22) Filed: Apr. 30, 2012

(30) Foreign Application Priority Data
Aug. 26, 2011 (CN) 201110248574.7

(51) Int. Cl. G06F 15/177

(52) U.S. Cl. 713/2

(57) ABSTRACT

A software execution method is provided. The software execution method includes the following steps. An operating system kernel is started, which is commonly used by a first operating system and a second operating system. One or more driver modules is loaded into the kernel of the first operating system. Under a root of one of the first and the second operating systems, the one of the first and the second operating systems can start to be performed. A procedure is forked to chroot a root of the other one of the first and second operating systems. Under the root of the other one of the first and the second operating systems, the other one of the first and the second operating systems can start to be performed. An electronic device using the same is also provided.

### CROSS-REFERENCE TO RELATED APPLICATION

This application claims the priority benefit of China application serial no. 201110248574.7, filed on Aug. 26, 2011. The entirety of the above-mentioned patent application is hereby incorporated by reference herein and made a part of this specification.

### BACKGROUND OF THE INVENTION

1. Technical Field

The invention relates to a software execution method and an electronic device using the same. More particularly, the invention relates to a software execution method and an electronic device using the same under a dual operating system.

2. Background

In a dual operating system with different libraries, if one of the operating system is to execute software of the other operating system, then the software must be correspondingly modified to a substantial extent, so that the one of the operating systems is able to successfully operate the software of the other operating system.

For example, the current Android operating system is extensively used in many fields, such as smart phones and smart televisions. In the field of televisions, many solutions for Linux-based television software have been proposed before the Android operating system. The Android operating system is based on the Linux operation system, but have been modified substantially, particularly regarding C libraries. The Android operating system does not adopt a glibc library to serve as the C library, but rather adopts a Bionic Libc library developed by Google. The toolchains for file compilation are also based on Bionic Libc libraries, rather than glibc libraries.

This causes many current multi-media application programs to have a difficult time being adapted to the Android operating systems and thus require substantial modifications, which include communication with Java processes and bottom level C libraries via communication interfaces such as a Java Native Interface (JNI). Consequently, the difficulty in using multi-media application programs is increased.

### SUMMARY OF THE INVENTION

The disclosure provides a software execution method, capable of launching existent application programs based on specific libraries under a dual operating system, and directly running these application programs without modifying them basically.

The disclosure further provides an electronic device with a dual operating system, adapted to perform the aforementioned software execution method.

According to an aspect of the disclosure, a software execution method is provided, including the following steps. An operating system kernel is started. The operating system kernel is commonly used by a first operating system and a second operating system. One or more driver modules are loaded into the operating system kernel. Under a root of one of the first operating system and the second operating system, the one of the first operating system and the second operating system is started to be executed. A procedure is forked, so as to chroot a root of the other one of the first operating system and the second operating system. Under the root of the other one of the first operating system and the second operating system, the other one of the first operating system and the second operating system is started to be executed.

In an embodiment, the type of the operating system kernel is the type of a kernel of the first operating system.

In an embodiment, each of the roots of the first and the second operating systems stores both file structures of the first operating system and the second operating system.

In an embodiment, the step of starting to execute the one of the first and the second operating systems includes using at least one of the one or more driver modules and the library of the one of the first and the second operating systems, to start executing one or more application programs of the one of the first and the second operating systems.

In an embodiment, the at least one of the one or more driver modules is exclusively used by the one of the first and the second operating systems, or is commonly used by the first and the second operating systems.

In an embodiment, the step of starting to execute the one of the first and the second operating systems occurs before, after, or at the same time as the step of forking a procedure.

In an embodiment, the step of starting to execute the one of the first and the second operating systems occurs before, after, or at the same time as the step of starting to execute the other one of the first and the second operating systems.

In an embodiment, the step of starting to execute the other one of the first and the second operating systems includes using at least one of the one or more driver modules and the library of the second operating system, to start executing one or more application programs of the other one of the first and the second operating systems.

In an embodiment, the at least one of the one or more driver modules is exclusively used by the other one of the first and the second operating system, or is commonly used by the first and the second operating systems.

In an embodiment, the first operating system is a Linux operating system.

In an embodiment, the second operating system is an Android operating system.

In an embodiment, the one or more driver modules include one or more first driver modules. At least one of the one or more first driver modules is used during the execution of the first operating system, and is selected from at least one of the following driver modules: an audio driver module, a video driver module, a graphic driver module, and a remote control driver module.

In an embodiment, the one or more driver modules further include one or more second driver modules. At least one of the one or more second driver modules is used during the execution of the second operating system, and is selected from at least one of the following driver modules: a flash memory driver module, a universal serial bus driver module, a binder inter-process communication driver module, an Ethernet driver module, and a power management driver module.

In an embodiment, at least one of the one or more driver modules is used by the first operating system or the second operating system alone.

In an embodiment, at least one of the one or more driver modules is commonly used by both the first operating system and the second operating system.

In an embodiment, the step of chrooting a root of the other one of the first operating system and the second operating system is performed through a chroot function.

In an embodiment, the software execution method further includes executing an application program management procedure. The application program management procedure centrally manages the execution of the application programs of the first operating system and the second operating system.

In an embodiment, the application program management procedure further controls the switching of an application environment between the application programs of the first operating system and the application programs the second operating system.

According to another aspect of the disclosure, an electronic device with a dual operating system is provided, including a memory device and a processor. The memory device stores a plurality of commands, which are used to execute the software execution method. The processor accesses the memory device to execute the plurality of commands.

Based on the above, in the present embodiments, the application programs of the first and the second operating systems can operate at the same time, and modifications to the application programs of either operating system are basically not required.

In order to make the aforementioned and other objects, features and advantages of the disclosure comprehensible, embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic framework diagram of a dual operating system according to an embodiment of the invention.

FIG. 2 is a flowchart illustrating a software execution method according to an embodiment of the invention.

FIG. 3 is a flowchart illustrating a software execution method according to another embodiment of the invention.

FIG. 4 is a schematic diagram of an electronic device having a dual operating system according to an embodiment of the invention.

### DETAILED DESCRIPTION OF DISCLOSED EMBODIMENTS

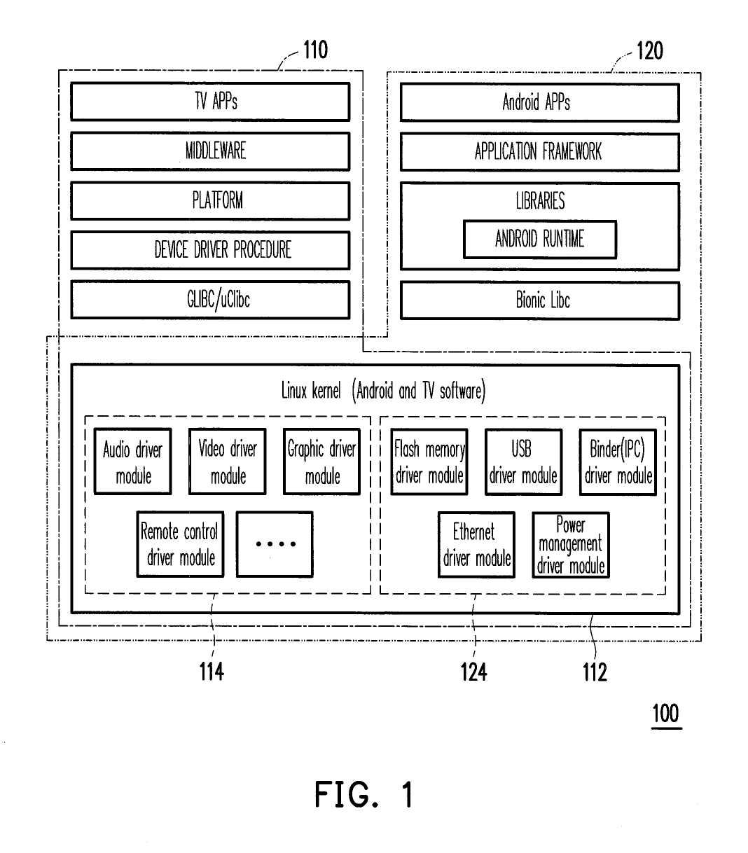

FIG. 1 is a schematic framework diagram of a dual operating system according to an embodiment of the invention. Referring to FIG. 1, the dual operating system 100 of the present embodiment includes a first operating system 110 and a second operating system 120. The first operating system 110 is, for example, a Linux operating system, and the second operating system 120 is, for example, an Android operating system, but the invention is not limited thereto.

In the present embodiment, the first operating system 110 and the second operating system 120 commonly provide an application environment for operating multi-media application programs based on a Linux operating system and an Android operating system. In the exemplary embodiments described hereafter, the multi-media application programs are described as television application programs and application programs of the Android operating system, but the invention is not limited thereto. Alternatively, the multi-media application programs can also be multi-media application programs executable on any electronic device with a dual operating system such as a tablet computer, a notebook computer, or a smart phone.

Regarding the first operating system 110, a system framework of the first operating system 110 includes television application programs, a middleware, a platform, a device driver procedure, a GLIBC/uClibc library, and a Linux operating system kernel 112 commonly used with the second operating system 120.

Regarding the second operating system 120, a system framework of the second operating system 120 includes Android operating system application programs, an application framework, libraries and Android runtime, a Bionic Libc library, and the Linux operating system kernel 112 commonly used with the first operating system 110. The description of the system frameworks of the first operating system 110 and the second operating system 120 are only exemplary, and the invention is not limited thereto.

When the dual operating system 100 is ready, application programs thereof can be operated by a multi-process method. Thus, the system framework of the present embodiment can further include an application program management unit (not shown), to harmonize the tasks of the application programs of the Android operating system and the television application programs. The task of the application program management unit includes but is not limited to tasks such as resource management and scene switching. The resource management task includes management tasks of resources such as a remote controller, an audio/video decoder, a screen, and a graphics layer. The scene switching task includes switching from the application environment of the Android operating system to the application environment of the television software, or switching from the application environment of the television software to the application environment of the Android operating system. Thus, the application program management unit of the present embodiment executes an application program management procedure, to centrally manage the execution of the application programs of the first operating system 110 and the second operating system 120. In addition, the application program management unit uses the application program management procedure to control the switching of the application environment between the application programs of the first operating system 110 and the application programs of the second operating system 120.

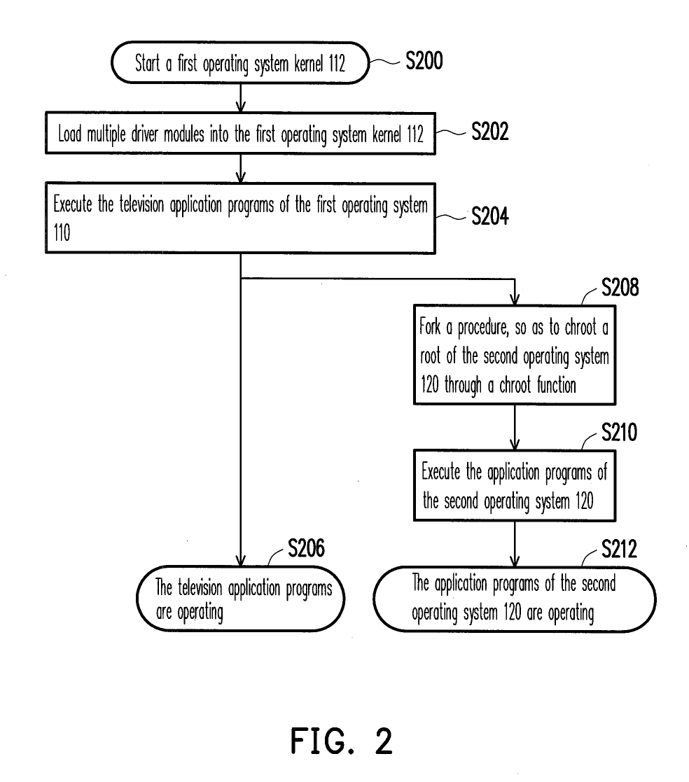

FIG. 2 is a flowchart illustrating a software execution method according to an embodiment of the invention. Referring to FIG. 1 and FIG. 2, in step S200, the software execution method first starts an operating system kernel. The operating system kernel is commonly used by the first operating system 110 and the second operating system 120. A preferable type of the operating system kernel 112 is designed as a type of a kernel of the first operating system 110, which is, in this embodiment, a Linux operating system kernel 112.

Next, in step S202, multiple driver modules are loaded into the operating system kernel 112 (i.e. the Linux operating system kernel 112). In the present embodiment, the driver modules loaded into the Linux operating system kernel 112 can, for example, include a first driver module 114 required for driving a multi-media function, and a second driver module 124 required for driving a system management function.

More specifically, the first driver module 114 is used during the execution of the first operating system 110, and includes at least one of multiple driver modules such as an audio driver module, a video driver module, a graphic driver module, and a remote control driver module, so that the electronic device can execute a multi-media function. The second driver module 124 is used during the execution of the second operating system 120, and includes at least one of multiple driver modules such as a flash memory driver module, a universal serial bus driver module, a binder inter-process communication driver module, an Ethernet driver module, and a power management driver module, so that the system of the electronic device can successfully operate. The driver modules included in the first driver module 114 and the second driver module 124 are only exemplary, and the invention is not limited thereto. It should be noted that a portion of driver modules of the first driver module 114 can be exclusively used by the first operating system 110, and the other portion of driver modules can be commonly used by the first operating system 110 and the second operating system 120. A portion of driver modules of the second driver module 124 can be exclusively used by the second operating system 120, and the other portion of driver modules can be commonly used by the first operating system 110 and the second operating system 120.

Then, in step S204, under a root of the first operating system 110, the software execution method uses the first driver module 114 and, for example, a GLIBC/uClibc library of the first operating system 110, to start executing application programs of the first operating system 110. For example, to drive a television to broadcast sound and display images, the software execution method, in step S204, can use the audio driver module and the video driver module of the first driver module 114, and the GLIBC/uClibc library to execute the audio and video related application programs of the first operating system 110. That is to say, the television application programs of the Linux operating system are executed. Thus, after step S204, the software execution method can continually operate the application programs of the first operating system 110, as seen in step S206. That is to say, the television application program is continuously operated.

Thereafter, in order to operate the application programs of the second operating system 120 at the same time, in step S208, the software execution method forks a procedure, so as to chroot a root of the second operating system 120 through, for example, a chroot function. In the embodiment, each of the roots of the first and the second operating systems 110 and 120 can store (better stored before the system is manufactured) file structures of the first and the second operating system 110 and 120, so that when the software execution respectively chroots the root of the first and the second operating systems 110 and 120 through a chroot function, the corresponding file function can be successfully executed. The so-called file structures can, for example, include executable programs, dynamic databases, script programs, pictures, audio frequency files, user configuration files, default parameters, and etc., required for starting the first operating system or the second operating system.

It should be noted that, in the present embodiment, the step S204 of starting to execute the first operating system 110 occurs before the step S208 of forking the chroot procedure, but the invention is not limited thereto. In another embodiment, the step S204 of starting to execute the first operating system 110 occurs after or at the same time as the step S208 of forking the chroot procedure.

Next, in step S210, under the root of the second operating system 120, the software execution method uses the second driver module 124 and, for example, a Bionic Libc library of the second operating system 120, to start executing application programs of the second operating system 120. For example, in order to perform energy-saving control on the entire the dual operating system 100, the software execution method, in step S210, can use the power management driver module of the second driver module 124 and the Bionic Libc library to execute the application programs of the second operating system 120 related to power management. That is to say, the application programs of the Android operating system are executed. Next, in step S212, the software execution method can continually operate the application programs of the second operating system 120. It should be noted that at the same time, the software execution method can also continually operate the application programs of the first operating system 110, as seen in step S206.

Thus, in the present embodiment, the application programs of the first and the second operating systems 110 and 120 can operate at the same time, and modifications to the application programs of either operating system are basically not required. Further, by using the application program management procedure, the execution of the application programs of the first operating system 110 and the second operating system 120 can be centrally managed.

It should be noted that, in the present embodiment, the step S204 of starting to execute the first operating system 110 occurs before the step S210 of starting to execute the second operating system 120, but the invention is not limited thereto. In other embodiments, the step S204 of starting to execute the first operating system 110 can occur at the same time or after the step S210 of starting to execute the second operating system 120. In practical applications, the order of executing the first operating system 110 and the second operating system 120 can be based on design requirements, or can be decided by the user. Further, either one of the application programs (i.e. the television application program) of the first operating system or the application programs of the second operating system do not have to be executed, and can be determined according to the user or the application requirements. In addition, during the execution, the execution of the application programs of the first or the second operating system can be interrupted by entering a sleep state as selected based on requirements.

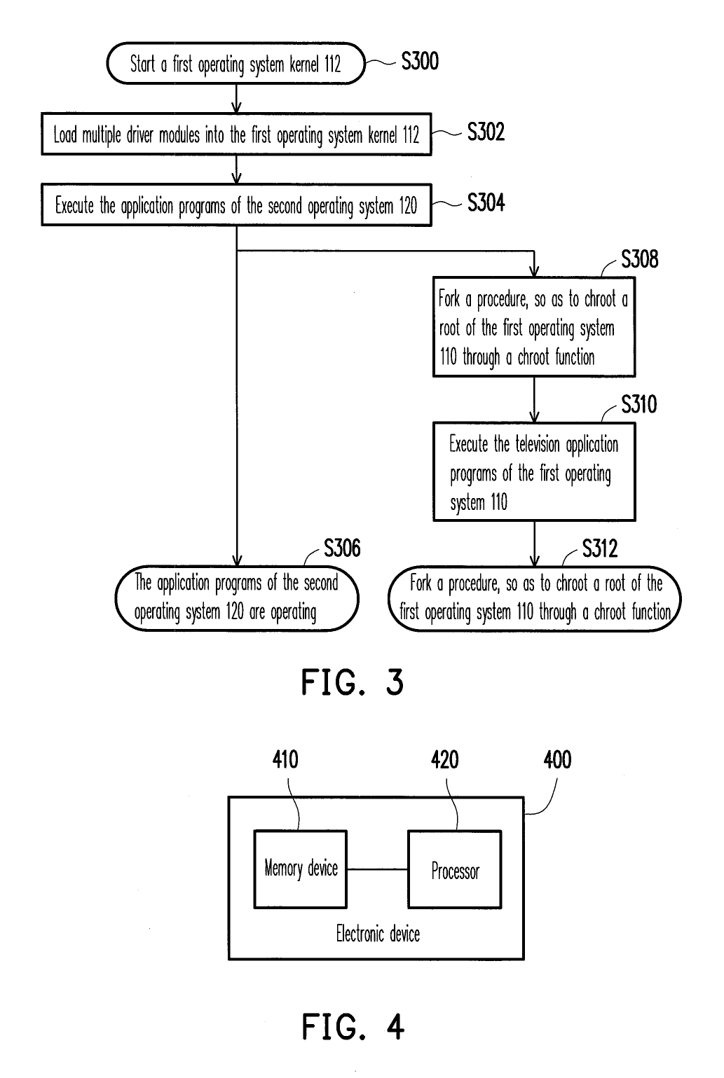

FIG. 3 is a flowchart illustrating a software execution method according to another embodiment of the invention. Referring to FIG. 1 to FIG. 3, the software execution method of the present embodiment is similar to the software execution method of FIG. 2. The main difference between the two embodiments is in the order of execution of the step of starting the first operating system 110 and the step of starting the second operating system 120.

In detail, in the present embodiment, after the software execution method loads a plurality of driver modules to the Linux operating system kernel 112 (i.e. completed in step S302), step S304 is started. In step S304, under the root of the second operating system 120, the software execution method uses the second driver module 124 and, for example, a Bionic Libc library of the second operating system 120, to start executing application programs of the second operating system 120. This step is similar to step S210, and the details will not be repeated herein.

Next, in step S306, the software execution method can continually operate the application programs of the second operating system 120. That is to say, the application programs of the Android operating system are continually operated.

On the other hand, in order to operate the application programs of the first operating system 110 at the same time, in step S308, the software execution method forks a procedure, so as to chroot the root of the first operating system 110 through, for example, the chroot function.

It should be noted that, in the present embodiment, the step S304 of starting to execute the second operating system 120 occurs before the step S308 of forking the chroot procedure, but the invention is not limited thereto. In another embodiment, the step S304 of starting to execute the second operating system 120 occurs after or at the same time as the step S308 of forking the chroot procedure.

Then, in step S310, under the root of the first operating system 110, the software execution method uses the first driver module 114 and, for example, a GLIBC/uClibc library of the first operating system 110, to start executing application programs of the first operating system 110. This step is similar to step S204, and the details will not be repeated herein. It can be seen that in the present embodiment, the step S310 of starting to execute the first operating system 110 can occur at the same time or after the step S304 of starting to execute the second operating system 120.

Next, after step S312, the software execution method can continually operate the application programs of the first operating system 110. It should be noted that at the same time, the software execution method can also continually operate the application programs of the second operating system 120, as seen in step S306.

FIG. 4 is a schematic diagram of an electronic device having a dual operating system according to an embodiment of the invention. Referring to FIG. 4, the electronic device 400 of the present embodiment is at least adapted to the software execution method of FIG. 2 and FIG. 3. The electronic device 400 includes a memory device 410 and a processor 420. The memory device 410 stores a plurality of commands, which are used to execute the software execution method of FIG. 2 or FIG. 3. The processor 420 accesses the memory device 410 to execute the commands. The electronic device 400 can be but is not limited to any specific electronic device with a dual operating system such as a tablet computer, a notebook computer, or a smart phone.

To sum up, in the present embodiments of the invention, the application programs of the first and the second operating systems can operate at the same time regardless of whether the application programs of one of the operating systems were executed first or the application programs of both operating systems were executed at the same time. Modifications to the application programs of either operating system are basically not required. In addition, the sequence of the step of chrooting the root procedure does not affect the application programs of the first and the second operating systems operating at the same time. Further, by using the application program management procedure, the execution of the applications of the first operating system and the second operating system can be centrally managed.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A software execution method comprising:
starting an operating system kernel, wherein the operating system kernel is commonly used by a first operating system and a second operating system;
loading one or more driver modules into the operating system kernel;
under a root of one of the first operating system and the second operating system, starting to execute the one of the first operating system and the second operating system;
forking a procedure, so as to chroot a root of the other one of the first operating system and the second operating system; and
under the root of the other one of the first operating system and the second operating system, starting to execute the other one of the first operating system and the second operating system.

2. The software execution method as claimed in claim 1, wherein a type of the operating system kernel is a type of a kernel of the first operating system.

3. The software execution method as claimed in claim 1, wherein each of the roots of the first operating system and the second operating system stores both file structures of the first operating system and the second operating system.

4. The software execution method as claimed in claim 1, wherein the step of starting to execute the one of the first operating system and the second operating system comprises:
using at least one of the one or more driver modules and a library of the one of the first operating system and the second operating system, to start executing one or more application programs of the one of the first operating system and the second operating system.

5. The software execution method as claimed in claim 4, wherein the at least one of the one or more driver modules is exclusively used by the one of the first operating system and the second operating system, or is commonly used by the first operating system and the second operating system.

6. The software execution method as claimed in claim 1, wherein the step of starting to execute the one of the first operating system and the second operating system occurs before, after, or at the same time as the step of forking the procedure.

7. The software execution method as claimed in claim 1, wherein the step of starting to execute the one of the first operating system and the second operating system occurs before, after, or at the same time as the step of starting to execute the other one of the first operating system and the second operating system.

8. The software execution method as claimed in claim 1, wherein the step of starting to execute the other one of the first operating system and the second operating system comprises:
using at least one of the one or more driver modules and a library of the second operating system, to start executing one or more application programs of the other one of the first operating system and the second operating system.

9. The software execution method as claimed in claim 8, wherein the at least one of the one or more driver modules is exclusively used by the other one of the first operating system and the second operating system, or is commonly used by the first operating system and the second operating system.

10. The software execution method as claimed in claim 2, wherein the first operating system is a Linux operating system.

11. The software execution method as claimed in claim 10, wherein the second operating system is an Android operating system.

12. The software execution method as claimed in claim 10, wherein the one or more first driver modules include one or more first driver modules, at least one of the one or more first driver modules is used during the execution of the first operating system, and the at least one of one or more first driver modules is selected from at least one of the following driver modules: an audio driver module, a video driver module, a graphic driver module, and a remote control driver module.

13. The software execution method as claimed in claim 11, wherein the one or more driver modules include one or more second driver modules, at least one of the one or more second driver modules is used during the execution of the second operating system, and the at least one of one or more second driver modules is selected from at least one of the following driver modules: a flash memory driver module, an universal serial bus driver module, a binder inter-process communication driver module, an Ethernet driver module, and a power management driver module.

14. The software execution method as claimed in claim 1, wherein at least one of the one or more driver modules is used by the first operating system or the second operating system alone.

15. The software execution method as claimed in claim 1, wherein at least one of the one or more driver modules is commonly used by the first operating system and the second operating system.

16. The software execution method as claimed in claim 11, wherein the step of chrooting a root of the other one of the first operating system and the second operating system is performed through a chroot function.

17. The software execution method as claimed in claim 1, further comprising:
executing an application management procedure, so as to centrally manage the execution of application programs of the first operating system and the second operating system.

18. The software execution method as claimed in claim 17, wherein the application program management procedure further controls the switching of an application environment between the application programs of the first operating system and the application programs the second operating system.

19. The software execution method as claimed in claim 1, wherein the first operating system is a Linux operating system, and the second operating system is an Android operating system.

20. The software execution method as claimed in claim 2, wherein the first operating system is a Linux operating system, and the second operating system is an Android operating system.

21. An electronic device having a dual operating system, comprising:
a memory device, storing a plurality of commands for executing the software execution method of claim 1; and
a processor, accessing the memory device to execute the plurality of commands.
